(19) United States
(12) Patent Application Publication
(10) Pub. No.: US 2024/0010087 A1
(43) Pub. Date: Jan. 11, 2024

(54) Systems and Methods for Charging Electric Vehicles

(71) Applicant: NXU Technologies, LLC, Tempe, AZ (US)

(72) Inventors: Victor Atlasman, Tempe, AZ (US); Rosten Sweeting, Tempe, AZ (US); Levi Clayton, Mesa, AZ (US)

(73) Assignee: NXU Technologies, LLC, Tempe, AZ (US)

(21) Appl. No.: 18/369,542

(22) Filed: Sep. 18, 2023

Related U.S. Application Data
(60) Provisional application No. 63/407,887, filed on Sep. 19, 2022.

(51) Int. Cl. B60L 53/30; B60L 53/31; B60L 53/66

(52) U.S. Cl. CPC B60L 53/305; B60L 53/31; B60L 53/66

(57) ABSTRACT

A charging system includes a server that receives information from a plurality of charging stations and a plurality of electric vehicles. The server is configured to analyze the information to predict and schedule future charging services for one or more electric vehicles of the plurality of electric vehicles. The server is further configured to predict an amount of electrical energy needed for future charging services for the one or more electric vehicles. The server is further configured to instruct the predicted service stations that will provide the service to store a portion of the predicted required electrical energy in a respective battery bank associated with the service station for delivery to an electric vehicle.

### BACKGROUND

Embodiments of the present invention relate to charging electric vehicles.

The amount of power provided to a charging station from an electric utility company (e.g., line power) may not be sufficient to provide charging services to all electric vehicles desiring to be charged at a given time. Charging stations would benefit from storing electrical energy to supplement the line power when charging electric vehicles. Further, charging stations would benefit from techniques for determining when to store electrical energy to provide future charging services.

### SUMMARY

A charging station receives electrical energy (e.g., power, energy, line power) from an electric utility company via transmission lines. The transmission lines are limited in the amount of electrical energy that the electric utility can provide. In other words, the transmission lines have a maximum power capacity. A charging station may include a battery bank for storing electrical energy for later use to charge electric vehicles. The charging station may store electrical energy when the amount of electrical energy being used to charge electric vehicles is less than the maximum power capacity of the transmission lines. The charging station may also decrease the amount of electrical energy presently being provided to electrical vehicles to be able to store electrical energy for future charging services. The charging station and/or a server may predict a time when demand for electrical energy exceeds the line capacity and thereby determine the amount of energy to store in preparation for the future demand.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is a diagram of an example embodiment of a charging system according to various aspects of the present disclosure.

FIG. 2 is a diagram of an example embodiment of a charging station according to various aspects of the present disclosure.

FIG. 3 is a diagram of an example embodiment of a battery bank.

FIG. 4 is a diagram of an example embodiment of a database for storing information regarding storing electrical energy for future delivery.

FIG. 5 is a diagram of an example embodiment for verifying the identifier of an electric vehicle prior to delivering stored electrical energy.

FIG. 6 is a diagram of a user taking a physical action to confirm a predicted reservation.

FIG. 7 is a diagram of a map of an example city.

FIG. 8 is a diagram of a map of an example geographic area.

### DETAILED DESCRIPTION

### Overview

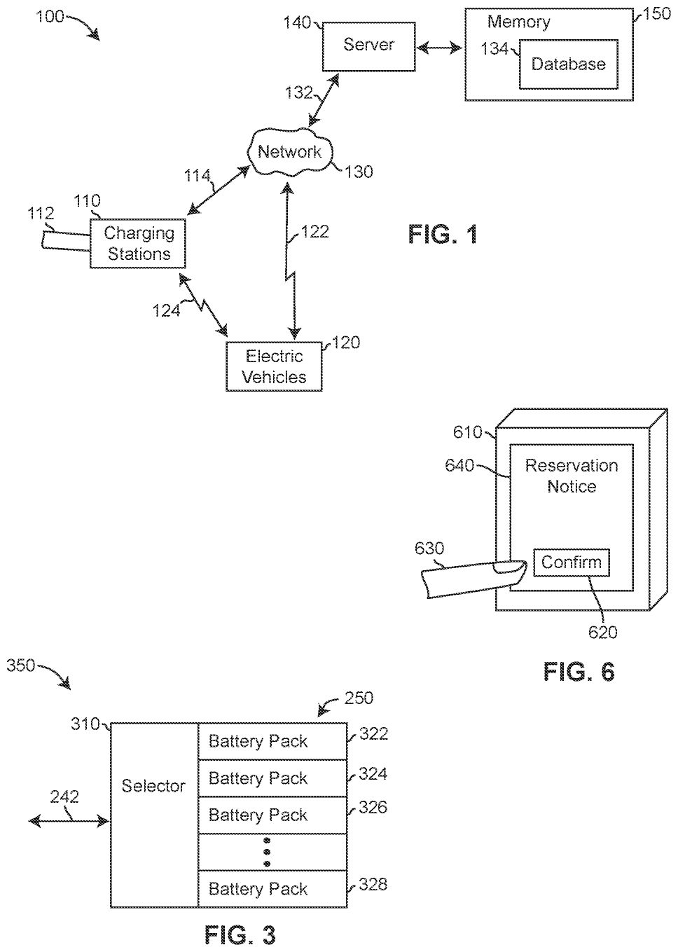

In an example embodiment, a charging system 100 (e.g., system for charging), best shown in FIG. 1, includes charging stations 110, electric vehicles 120, a network 130, a server 140 and a memory 150. The memory 150 includes a database 160. The charging stations 110 receives electrical energy (e.g., power) from an electric utility company via respective transmission lines 112. In addition to the electrical power received via the transmission lines 112, the charging stations 110 may receive electrical energy from locally generated sources (e.g., local sources 280)), such as electrical energy from renewable sources (e.g., local solar panels, local wind turbine) and/or from non-renewable sources (e.g., local diesel generator). The respective transmission lines 112 provide a maximum amount of electrical energy to each respective charging station 110. The respective electrical vehicles 120 are driven by the users until it is time to recharge the respective batteries of the electric vehicles 120. The charging stations 110 and the electric vehicles 120 communicate with the server 140 via network 130. The charging stations 110 may communicate with the electric vehicles 120 via the network 130 and/or directly via a wireless communication link (e.g., 124).

In an example embodiment, the charging stations 110 respectively provide information to the server 140 regarding its geographic location (e.g., where it is positioned, where it is located), configuration, operation and other information (e.g., see Tables 1 and 2). In an example embodiment, the electric vehicles 120 provide information to the server 140 regarding their respective operation, users, charging services received, navigation information and other information (e.g., see Table 3). Information provided by the charging stations 110 and the electric vehicles 120 to the server 140 may be updated regularly and even frequently, possibly in near real-time.

Further, each user or each family of users of the electric vehicles 120 provides information to the server 140 regarding user preferences, such as, the amount of time or money they are willing to spend to recharge their vehicle and where they are willing or not willing to charge their vehicles (e.g., see Table 6). Some users may have a low tolerance (e.g., preferences) for the amount of time it takes to charge their vehicle but are more tolerant as to the amount of money they pay to recharge their vehicle. Some users may be more tolerant as to the time or money they pay to recharge their vehicle but are less tolerant as to the location of the charging station. Some users may be more tolerant of the time it takes to charge their vehicle or the location of the charging station, but less tolerant as to the cost.

The server 140 stores the information from the charging stations 110, the electric vehicles 120 and from the users in the database 160. In an example embodiment, the server 140 uses the information in the database 160 to predict events that may occur in the future. The server 140 may detect patterns that occur in the data stored in the database 160 to predict events that may occur in the future. For example, the server 140 may predict, among other things, an approximate time when an electric vehicle will need to be recharged, a charging station capable of providing the charging services within the preferences of the user and the users preferred charging station under the circumstances.

Responsive to its predictions, the server 140 may, among other things, reserve a charger at a particular charging station for a specific window of time for a particular electric vehicle, instruct a charging station to store a certain amount of electrical energy in its battery bank (e.g., 250) to provide to a particular electric vehicle sometime in the future. The server 140 may further send a message to the user of the particular electric vehicle regarding the predicted time of service. The actions taken by the server to reserve a charger and store energy may be dependent upon a physical action taken by the user to confirm the predicted time of service and the users desire to charge the particular electric vehicle at the predicted time and place in the future. The physical action required by the user may include physically responding (e.g., touching, selecting, operating mouse) to confirm the predicted information. Manual action taken by a user to confirm the predicted information may be as simple as a finger of the user 630 physically contacting a confirmation icon 620 on the touch screen 640 of a device 610 as shown in FIG. 6. Manual action may further include manually operating a mouse to select an icon on a display of a computer or responding vocally to the reservation prompt on electronic device.

In another example embodiment, the server 140 identifies one or more charging stations 110 within an area where a user may receive near-immediate charging services and/or charging services at a particular cost. Responsive to a physical action taken by the user, the server 140 they reserve a bay at a particular charging station 110 and/or and amount of electrical energy for the user's electric vehicle.

One aspect of charging an electric vehicle, according to various aspects of the present disclosure, includes using data regarding past events to predict a need for charging services for a specific electric vehicle at a future time. Another aspect includes storing (e.g., reserving) electrical energy at one or more specific charging stations to provide charging services to the specific electric vehicle at the future time and in accordance with the user's preferences.

### Communication Links

In an example embodiment, the charging stations 110 and the electric vehicles 120 communicate with the server 140 via the network 130. Communication between the server 140 and the charging stations 110 and/or the electric vehicles 120 may occur via wired or wireless communication links. In an example embodiment, the charging stations 110 communicate with the network 130 via respective wired communication links 114. The electric vehicles 120 communicate with the network 130 via respective wireless communication links 122. The network 130 communicates with the server 140 via wired communication link 132. The network 130 enables communication between charging stations 110, charging stations 110 and electric vehicles 120, and electric vehicles 120.

In an example embodiment, the charging stations 110 may further communicate with the electric vehicles 120 directly via a wireless communication link 124. In this embodiment, a specific charging station 110 may communicate directly via a wireless communication link 124 with a specific electric vehicle 120 while the specific electric vehicle 120 is in wireless communication range of the specific charging station 110. In an example embodiment, the charging station 110 performs the function of a wireless access point that one or more electric vehicles 120 in the vicinity may use to communicate with the charging station 110 indoor with each other. In another example embodiment, the charging station 110 performs the function of a router that wirelessly communicates with one or more electric vehicles 120 or enables the one or more electric vehicles 120 to communicate with each other.

Any communication protocol may be used to communicate via any wired and/or wireless communication link (e.g., 114, 122, 124, 132). Communication via various communication links may occur at the same time. Communication via a communication link may be bidirectional.

### Charging Station

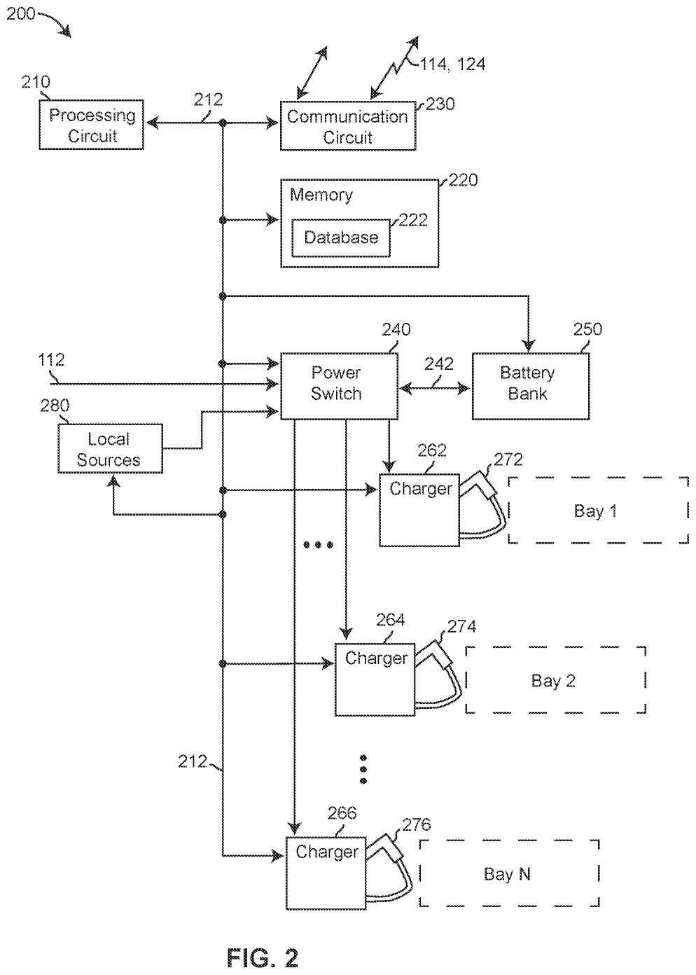

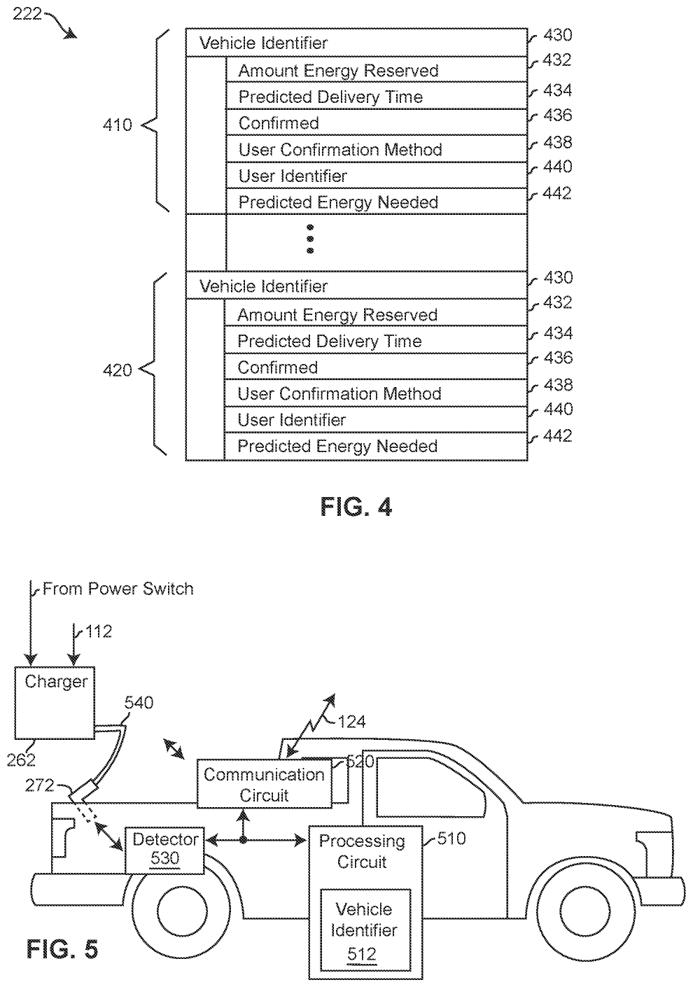

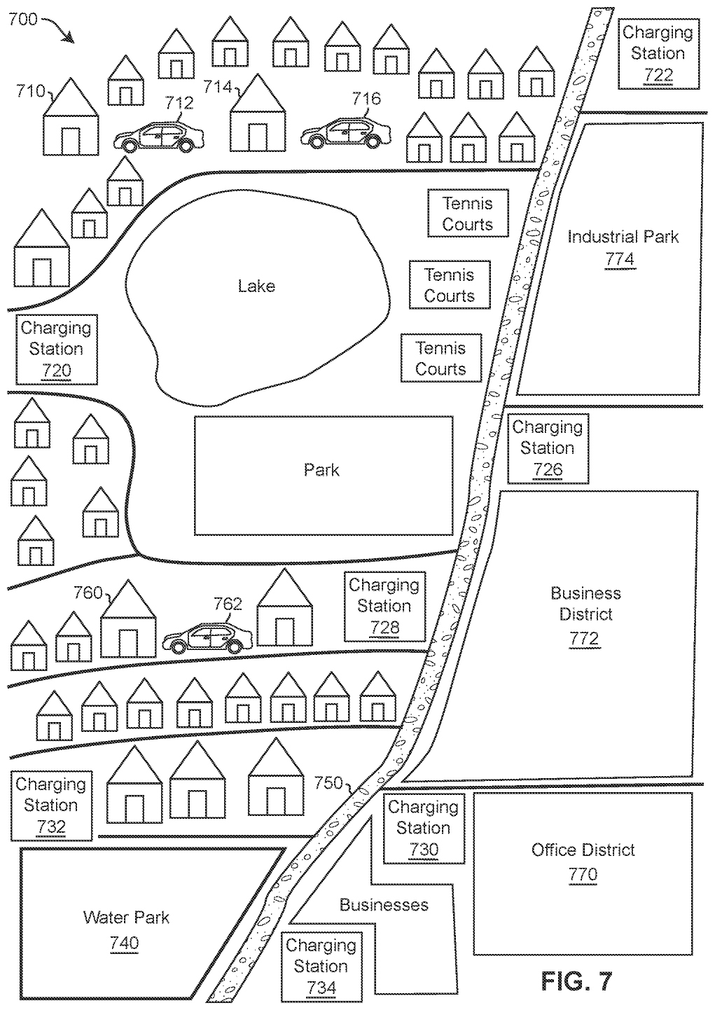

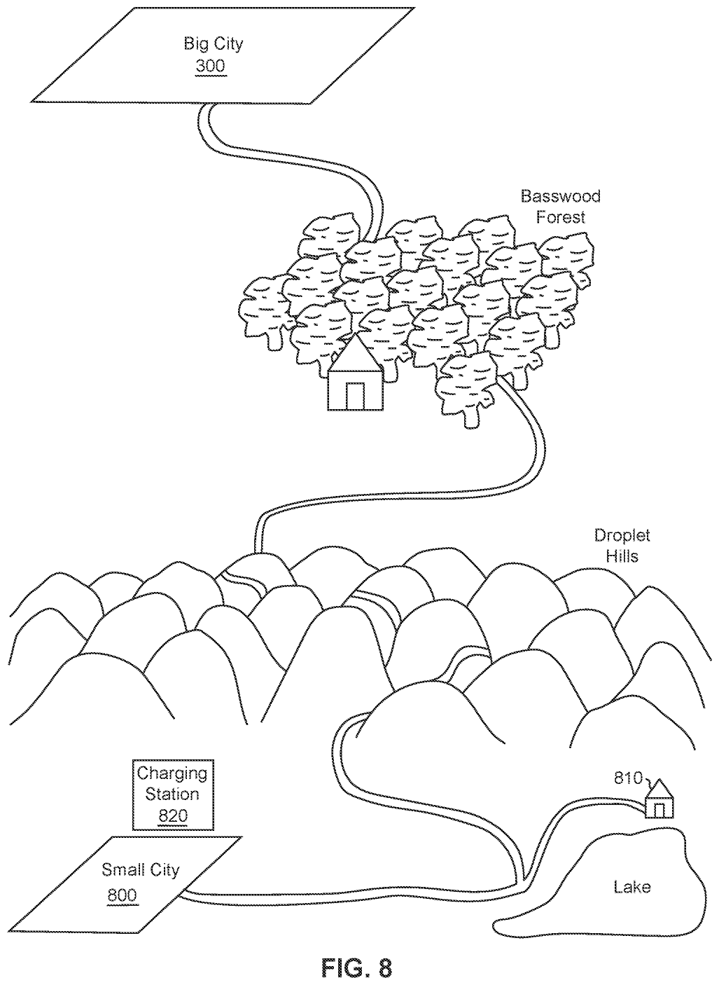

A charging station 200, best seen in FIG. 2, is an example embodiment of one of the charging stations 110. The charging station 200 includes a processing circuit 210, a memory 220, a communication circuit 230, a power switch 240, a battery bank 250 and chargers 260. The chargers 260 (e.g., 262, 264, 266) are respectively positioned in a bay (e.g., 1, 2, N). Each charger 262, 264 and 266 includes equipment (e.g., handle, cable) for charging one electric vehicle positioned in the bay associated with the charger. The handle (e.g., 272, 274, 276) is inserted into a socket of the electric vehicle 120 positioned in the bay. The handle connects to the charger via the cable. The cable and the handle electrically couple to the electric vehicle 120 to transfer energy to the battery of the electric vehicle to charge the battery an electric vehicle positioned in the bay.

The memory 220, as with memory 150, includes any type of memory, including semiconductor memory (e.g., RAM, ROM, Flash) and/or magnetic memory (e.g., hard drive), for storing data for access, storage and use by processing circuit 210. Data may be stored in the memory 220 in any format. For example, in an example embodiment, the memory 220 stores the database 222. The memory 220 may also store a program for execution by the processing circuit 210 for performing the functions of the charging station 200.

In an example embodiment, processing circuit 210 communicates with (e.g., sends, receives) and/or controls the components (e.g., communication circuit 230, memory 220, power switch 240, battery bank 250, charger 262, charger 264, charger 266) of the charging station 200 via bus 212. Bus 212 includes any type of bus. The bus 212 may include any number of lines (e.g., conductors). The bus 212 may include lines for addresses, data, and/or control signals. The processing circuit 210 may specify specific addresses on bus 212 to communicate with specific components of the charging station 200. Various lines of the bus 212 may provide continuous information between the processing circuit 210 and a components of the charging station 200. The bus 212 may communicate data as digital and/or analog signals.

The functions of the charging station 200 include receiving electrical energy via the transmission lines 112, providing electrical energy to the electric vehicles 120 via the chargers 260, storing electrical energy in the battery bank 250, receiving electrical energy from the battery bank 250, storing information in and retrieving information from database 222, and transmitting data to and receiving data from database 160 via server 140. Tables 1 and 2 identify at least some of the information provided by the charging station 202 the database 160. So beautiful

The processing circuit 210 includes any type of electronic and/or electromechanical device for controlling the operations of the charging station 200. The processing circuit 210 may include any number of microprocessors, digital processors, signal processors, switches, relays, solenoids and/or other electronic devices. The processing circuit 210 may control the power switch 240 so as to control the reception of electrical energy via the transmission lines 112, the storage of electrical energy in the battery bank 250, the provision of electrical energy from the transmission lines 112 to one or more electric vehicles, the provision of electrical energy from the battery bank 250 and/or the dispensing (e.g., provision) of electrical energy to one or more electric vehicles via the chargers (e.g., 262, 264, 266). In another embodiment, best seen in FIG. 3, the processing circuit 210 further controls the selector 310.

The processing circuit 210 is configured to control the power switch 240 to control the amount of energy provided by transmission lines 112 and battery bank 250 to a specific electric vehicle via the chargers 262, 264 and 266. For example, of the total electrical energy provided to a specific electric vehicle, the processing circuit 210 may control the power switch 240 so that 20% of the total energy be provided by the transmission lines 112 while the remaining 80% be provided by the battery bank 250. The processing circuit 210 may determine the amount of energy provided by the transmission lines 112 to electric vehicles via chargers 262, 264 and 266 and the amount of energy that is stored in or retrieved from the battery bank 250 at any time. The processing circuit 210 is configured to control the power switch 240 to steer the electrical power as determined by the processing circuit 210 and/or the server 140.

The power switch 240 may optionally receive electrical energy from one or more local sources 280. Local sources 280 may include renewable sources of electrical energy such as solar panels and wind turbines. Local sources 280 may further include nonrenewable sources of electrical energy such as a gas, diesel, propane or natural gas generator. The operation of the local sources 280 may be under the control of the processing circuit 210. The processing circuit 210 may control the local sources 280 so that they provide electrical energy only when needed. In an example embodiment, the processing circuit 210 permits the renewable sources of electrical energy to continuously provide energy, whereas the processing circuit 210 causes the nonrenewable sources of electrical energy to operate only when necessary to meet demand.

Local sources 280 may include a mobile battery as described in U.S. provisional patent application 63/467,869 filed May 19, 2023 entitled “Systems and Methods for Meeting Demand at Charging Stations”, which is incorporated by reference for all purposes.

The power switch 240 includes any type of electrical, electromechanical and/or electronic devices needed to direct the flow of electrical energy (e.g., current) from a source (e.g., transmission lines 112, local sources 280, battery bank 250) to a destination (e.g., electric vehicle 120, battery bank 250). The power switch 240 may include any type of power conditioner (e.g., filter, rectifier, chopper) or converter (e.g., transformer, AC-to-DC, AC-to-AC, DC-to-DC) needed to convert the characteristics of the electrical energy from a source to the electrical characteristics needed at the destination. The processing circuit 210 may control the operation of all conditioners and/or converters. In an example embodiment, power switch 240 includes AC-to-DC converters to convert the AC electrical energy provided by transmission lines 112 to DC electrical energy needed by the battery pack 250 and/or the electric vehicles 120 via the chargers 262, 264 and 266. In an example embodiment, power switch 240 includes DC-to-DC converters to convert DC electrical energy from the battery pack 252 the type of DC electrical energy needed by the electric vehicles 120. The power switch 240 includes any type of electrical, electromechanical and/or electronic devices needed to combine the electrical energy from one source, for example the transmission lines 112, with the electrical energy from any other source, for example the battery bank 250, for provision to a destination, for example an electric vehicle 120 via a charger (e.g., 262, 264, 266).

The processing circuit 210 is configured to determine (e.g., set, fix, adjust) the amount of electrical energy to be provided to any one electric vehicle and the source of the electrical energy (e.g., transmission line, battery bank, local sources). The processing circuit 210 may determine and/or control the rate of energy electrical delivery from any one source at a given time. The processing circuit 210 may further determine and/or control the rate of energy electrical delivery to any one electric vehicle at a given time via any of the chargers (262, 264, 266). In other words, processing circuit 210 may determine and/or control the amount of electrical energy and rate of delivery from any source to an electric vehicle being serviced by a charger, which means that the processing circuit 210 is configured to control the amount of time that will take to charge the electric vehicle being serviced by the charger. The processing circuit 210 may determine and/or control the amount of electric energy provided by any source to the electric vehicle being serviced by a charger, which means that the processing circuit 210 earmark (e.g., identify) an amount of electrical energy from a source that is to be delivered to a specific electric vehicle 120 at a specific future time.

The communication circuit 230 is configured to communicate with the network 130, the server 140 and/or the electric vehicles 120. The communication circuit 230 is configured to establish or eliminate wired and/or wireless communication links (e.g., 114, 124). The communication links 114 and/or 124 may include one or more communication links. The communication circuit 230 may perform the function of a wireless access point and/or a router. The communication circuit 230 may communicate via two or more communication links at the same time. The communication circuit 230 may use any suitable communication protocols.

The processing circuit 210 may control the communication circuit in whole or in part. The processing circuit 210 may send data to and/or receive data from the server 140 and/or the electric vehicles 120 via the communication circuit 230. The processing circuit 210 may use data received from the server 140 and or the electric vehicles 120 to control the operation of the charging station 200. For example, a specific electric vehicle 120 may inform the charging station 200 with respect to the amount of energy needed to recharge the battery of the specific electric vehicle 120. The processing circuit 210 may control the power switch 240 to transfer power from the transmission lines 112 to the battery bank 250 to prepare for providing electrical energy to the specific electric vehicle 120. The processing circuit 210 may receive communications from a user of the electric vehicle 120. For example, in response to a reservation message from the charging station 200 and/or the server 140, the user may physically touch a control (e.g., switch, button, portion of a touch screen, mouse) in the electric vehicle 120 or on an electronic device (e.g., smart phone, tablet) to send information to the processing circuit 210. The processing circuit 210 is configured to perform a function responsive to the physical action of the user responsive to future reservation notice. For example, responsive to the user pressing a control in the electric vehicle to confirm a future reservation notice, the processing circuit 210 controls the power switch 240 to send electrical energy to the battery bank 250 in reserve for the specific electric vehicle 120 driven by the user.

The processing circuit 210 may also receive commands from the server 140 to perform an operation. For example, the server 140 may predict that a specific electric vehicle 120 will need charging at a specific future time at a specific charging station 200. The server 140 is configured to instruct the specific charging station 200 to store electrical energy in the battery bank 250 in response to the prediction.

The processing circuit 210 may determine which chargers (e.g., 262, 264, 266) are available to service an electric vehicle. The processing circuit 210 may reserve a specific charger, and therefore the bay associated with the specific charger, to provide service to a specific electric vehicle during a specific window of time (e.g., a reservation, a reserved time). During the time of the reservation, no electric vehicle other than the specific electric vehicle for which the charger is reserved may use the reserved charger or its associated bay.

As discussed above, the charging stations 110 our configured to provide information to the server 140. In an example embodiment, each charging station 110 respectively provides the server 140 with information such as, inter alia, the information identified in Table 1 below.

TABLE 1
Charging Station Information

geographic location of the charging station
charging station identifier
number of bays
maximum rate of electrical energy delivery per charger
minimum rate of electrical energy delivered per charger
compatibility with electric vehicle models
hours of operation
hours of peak traffic
maximum amount of electrical energy provided by the utility via the
transmission lines 112
the storage capacity of the battery bank 250
the amount of electrical energy presently stored in the battery bank 250
age of the battery bank 250
number of charge-discharge cycles of the battery bank 250
number of hours of use of the battery bank 250
date and time of storing electrical energy in the battery bank 250
amount of electrical energy provided to the battery bank 250
rate of providing electrical energy to the battery bank 250
date and time of taking electrical energy from the battery bank 250
amount of electrical energy taken from the battery bank 250
the rate of taking electrical energy from the battery bank 250
amount of electrical energy stored in the battery bank over time
date, time and duration that each bay is used to provide service,
the number of electric vehicles presently being charged
The number of electric vehicles waiting to be charged at any time
the amount of energy being used to charge the presently being charged
electric vehicles
amount of electrical energy being used from the battery bank 250
to charge electric vehicles
faults and/or errors in operation of the charging station
faults and/or errors in delivery of electrical energy from the electric utility.

Each charging station may further provide information regarding the electric vehicles 120 to which the charging station provides services or the electric vehicles that are presently seeking service from the charging station. In an example embodiment, a charging station is configured to report to the server 140, inter alia, the information identified in Table 2 below.

TABLE 2
Additional Charging Station Information

the date and time of each charging service provided
the make and model of electric vehicle serviced
the amount of energy stored in the battery of the electric vehicle at the
beginning of service
the amount of energy stored by the battery of the electric vehicle at the
termination of service
the identifying information of the electric vehicle serviced (e.g.,
VIN, serial number, identifier)
the identity of the user of the electric vehicle at the time of service
the identity of the owner of the electric vehicle
the amount of electrical energy provided during servicing of each electric
vehicle
the rate of delivery of electrical energy to the electric vehicles via each
charger
the amount of time required to charge the electric vehicles via each
charger
the identifying information of the electric vehicles that arrived at the
charging station seeking services
the number of electric vehicles waiting for charging at any time
the identifying information of the electric vehicles that seek services from
the charging station but do not receive services

The above information may be provided regularly and possibly frequently by each charging station 110 to the server 140 so that the server 140 may create and store an accurate and timely historical record of each charging station, the services that it provides, the vehicles that it services and the electric vehicle traffic to the charging station. The server 140 may organize and store information from the charging stations 110 in the database 160 in any manner. For example, information may be organized by charging station and/or by date. In another example embodiment, the server 140 stores information regarding a charging station that does not change as a profile of the charging station and information that changes with time as a historical record of the charging station.

Maintaining a historical record of information from the charging stations 110 enables the server 140 to recognize patterns (e.g., demand cycles, repeat users, frequency of services to a specific vehicle, energy demands over time, energy demands during holidays) in the data to predict future demands or required electrical energy levels. The server 140 may use machine learning techniques to detect patterns in the data for the charging stations 110. Patterns that have been detected may be extrapolated into the future to predict likely future demands or needs.

### Electric Vehicles

In an example embodiment, the electric vehicles 120 include any type of electric vehicle suitable for being charged at the charging stations 110. As discussed above, the electric vehicles 120 provide information to the server 140. In an example embodiment, the electric vehicles 120 provide information such as, inter alia, the information identified in Table 3 below.

TABLE 3
Electric Vehicle Information

identity of user
identity of the owner
locations to which electric vehicle has travelled or will travel
present location
present speed if passing (e.g., not stopping at) the charging station
present direction of travel if passing the charging station
the amount of daily travel (for a period of time in the past)
the routes by which the electric vehicle has travelled or will travel
destination of present trip
date and times of receiving charging services
location of receiving charging services
battery capacity
amount of electrical energy presently stored in the battery
amount of electrical energy stored in the battery prior to receiving
charging services
amount of electrical energy stored in the battery after receiving charging
services
amount of electrical energy stored in battery during travel (e.g., amount
over time)
rate of use of electrical energy from the battery over time during travel
the vehicle systems (e.g., electric motors, infotainment, HVAC, so forth)
operating during use of the electric vehicle
amount of electrical energy used by each vehicle system over time
gross weight (e.g., vehicle + loading) of vehicle during use
terrain traveled (e.g., elevation changes, road grade)
battery temperature over time
environmental temperature overtime
whether a trailer is being pulled and its weight

The electric vehicles 120 may provide information to the server 140 regularly and frequently, possibly in near real-time. Frequent updates of information to the server 140 enable the server 140 to know the present geographic location of the electric vehicles 120, current battery state, rate of electrical energy usage, and so forth.

The server 140 is configured to store information from the electric vehicles 120 in the database 160. The server 140 may classify and or characterize the information received from the electric vehicles 120 for storage in the database 160 in any manner. The database 160 enables the server 140 to access categories of information for each electric vehicle 120. The server 140 is configured to perform calculations and/or synthesize data from the database 160 and store the result in the database 160. Information may be calculated and or synthesized on an individual electric vehicle basis and/or for groups of electric vehicles.

The server 140 may store information from the electric vehicles 120 that has been collected over any period of time. In an example embodiment, the server 140 collects information from an electric vehicle from the date of manufacture forward until the end of the electric vehicle's life. In another example embodiment, the server 140 collects information from an electric vehicle during the time of ownership by a specific owner. Maintaining a historical record of information from the electric vehicles 120 enables the server 140 to recognize patterns (e.g., user habits, user preferences, electric vehicle performance, electric vehicle efficiencies) in the data to predict future behavior of the user and/or the electric vehicle. The server 140 may use machine learning techniques to detect patterns in the data for one or more electric vehicles. Patterns that have been detected may be extrapolated into the future to predict likely future behavior or needs.

### Server

Using the information reported by the charging stations 110 and by the electric vehicles 120, the server 140 may determine, inter alia, the information identified in Table 4 below.

TABLE 4
Server Identified Information

chargers 260 utilization over time
electrical power utilization over time
dates and times of peak electrical energy delivery
dates and times of minimum electrical power delivery
dates and times of peak bay utilization
dates and times of minimum bay utilization
dates and times that electric vehicles sought but did not receiving service
the number and identity of electric vehicles that sought but did not receive
service
demand that could not be met due to utility transmission line, local sources
and/or stored electrical energy limitations
amount of electrical energy that could be stored in battery bank 250 during
minimum bay utilization
amount of electrical energy that should be stored during minimum bay
utilization to help meet peak electrical energy demand, and
amount electrical energy provided by local sources over time
How electrical energy from local sources was used over time
tolerances (e.g., preferences) of users serviced at the station

The server 140 is configured to use the collected data to determine information and/or habits regarding specific electric vehicles and or specific users. For example, the server 140 may determine the following, among other things, regarding specific vehicles and users as shown in Table 5 below.

TABLE 5
Additional Server Identified Information

preferred charging station
habitual times for charging
preferred amenities at a charging station
low energy point on battery (e.g., percent charge, 5%) that prompts
recharging
high energy point on battery after charging (e.g., percent charge, 100%)
time to charge battery tolerance
recharging cost tolerance
recharging time tolerance

Because the server 140 receives information from each charging station 110 and each electric vehicle 120, the server 140 may receive information regarding charging stations and electric vehicles over a wide area. Further, because the server 140 builds and maintains historical records of the information (e.g., database 160) provided by the charging stations 110, the electric vehicles 120 and/or user preferences, the server is able to detect patterns with respect to individual charging stations, groups (e.g., clusters) of charging stations and an area, individual electric vehicles, groups of electric vehicles, individual users, groups of users, and user behavior responsive to events such as holidays, personal events (e.g., birthday, anniversary), weather, and emergency situations.

The server 140 may use the information it collects, the patterns it detects, or any other result of analysis of the information it collects to configure the charging system 100 to better provide services. For example, in an example embodiment, the server 140 uses its information and analysis to store electrical energy in battery bank 250 of selected charging stations to meet predicted charging needs in accordance with detected patterns. In another example embodiment, the server 140 increases the electrical energy provided by local sources of selected charging stations to meet predicted charging needs in accordance with detected patterns. In another example, server 140 reserves a charger (e.g., bay) at a particular charging station at a particular time for a particular vehicle driven by a particular user with or without receiving a request for the reservation from the user in accordance with detected patterns.

In an example embodiment, the server 140 sends a message to the particular user regarding a predicted need for services at a future time. Responsive to a confirmation from the user that the user will seek the services at the future time, the server is configured to control the specific charging station 110 to implement the reservation of charger and storage of electrical energy in accordance with the predicted need for services and confirmation by the user. In an example embodiment, the user must take a physical action to confirm that the user will seek the predicted services at the predicted future time. A physical action by a user may include manual operation of a control (e.g., press button, touch icon on touch screen). Absent the physical action from the user, the server 140 does not instruct the charging stations 110 to implement a reservation for services or the storage of energy.

In another example embodiment, the server 140 predicts a need for services for a specific electric vehicle driven by a specific user at a future time at a specific charging station. Because demand is low at the specific charging station, the server 140 reserves a bay at the specific charging station for the future time and instructs the charging station to store a specific amount of electrical energy for delivery to the specific vehicle at the future time. The server 140 does not send a message to the user regarding the reservation because if the user does not arrive at the future time the reservation of the bay and energy has not affected any other vehicle or user. If the user does arrive at the future time, the reserved bay and electrical energy may be provided to the user.

The server 140 may detect patterns related to the particular electric vehicle and/or the particular user and reserve a charger at a particular charging station in accordance with past behavior. Further, the server 140 may ensure that the energy stored in the battery bank 250 and the amount of energy delivered by the transmission lines 112 and/or the local sources 280 is suitable to charge a specific electric vehicle when driven by a specific user in the amount of time that is within the tolerance of the specific user. In other words, the server 140 is configured to use information to detect patterns to prepare the equipment of the charging stations 110 to provide the services expected by or confirmed by the users.

The server 140 may further use information of database 160 and the results of analyzing the information to determine the type and quantity of equipment that each charging station should have to provide services. The demand for services from a particular charging station may depend on the geographic location of the charging station with respect to electric vehicles 120 located in the geographic area. For example, the server 140 may determine a suitable number of bays for each charging station. The server 140 may determine the geographic locations of future charging stations to best meet demand. The server 140 may determine an appropriate amount of storage capacity for the battery bank 250 of each charging station and/or an appropriate amount of energy generation capacity by local sources 280. The server 140 may determine if the maximum power capacity of the transmission lines 112 and/or the local sources 280 should be increased or decreased. The server 140 may determine the range and capacity of the communication circuit 230 of each charging station. In other words, whether the range should be increased or decreased and/or whether the communication link capacity of the communication circuit 230 should be increased or decreased.

### Energy Reservation

As discussed above, the server 140 may predict potential energy demand at one or more charging stations 110. To meet energy demands, the server 140 is configured to instruct a charging station to store electrical energy in the battery bank 250 to meet future demands and/or to increase energy generation by local sources 280.

In an example embodiment, the server 140 informs the processing circuit 210 of charging station 200 that a specific amount of energy is to be stored in the battery bank 250 by a specific time (e.g., date, time of day on a date). For example, on a Monday, the server 140 informs the charging station 200 that the battery bank 250 must store at least 900 MW of electrical energy by Friday at 4 PM to meet anticipated demand over the weekend. The processing circuit 210 and/or the server 140 is configured to perform calculations to know how much of the energy provided by the transmission lines 112 must be stored in the battery bank 250 between Monday and Friday.

In an example embodiment, the processing circuit 210 determines that the required amount of electrical energy may be stored in the battery bank 250 by storing 90% of the electrical energy provided by the transmission lines 112 each night (e.g., Monday, Tuesday, Wednesday, Thursday) between 11 PM and 5 AM. Accordingly, the processing circuit 210 controls the power switch 240 to steer 90% of electrical energy from the transmission lines 112 for storage in the battery bank 250 each night. The processing circuit may further control the power switch 240 to provide the remaining 10% of the electrical energy from the transmission lines 112 to the chargers 260 to charge electric vehicles 120. The remaining 10% of the electrical energy may be insufficient to charge multiple electric vehicles 120 at the same time, so the processing circuit 210 may shut down some of the chargers 260 so that they are not available. Further, the processing circuit 210 may broadcast information to electric vehicles 120 via the communication circuit 230 with respect to which chargers 260 are available and which chargers 260 are not available.

In another example embodiment, the processing circuit 210 stores electrical energy generated by local sources 280 in the battery bank 250 then uses the energy from the transmission lines 112, the local sources 280 and the amount of electrical energy in the battery bank 250 over the 900 MW that will be needed by Friday, to provide electrical energy to electric vehicles 120 and possibly shutting down fewer of the chargers 260 than would otherwise be needed without the electrical energy from the local sources 280.

In an example embodiment, the processing circuit 210 is configured to monitor the amount of electrical energy stored in the battery bank 250 to ensure that the required 900 MW is not prematurely used to charge electric vehicles 120. For example, assume that the battery bank 250 has capacity for storing 1500 MW of electrical energy. The processing circuit 210 may control the power switch 240 to provide electrical energy from the transmission lines 112, the local sources 280 and/or from the battery bank 250 to a charger (e.g., 262, 264, 266) as long as the amount of electrical energy stored by the battery bank 250 does not fall below 900 MW. When the electrical energy stored by the battery bank 250 decreases to 900 MW, the processing circuit 210 controls power switch 240 so that no additional energy is drawn from the battery bank 250. All energy provided to charge electric vehicles 120 via chargers 260 must then come from the transmission lines 112 and/or the local sources 280. If the amount of energy provided by the transmission lines 112 and/or the local sources 280 is not sufficient to charge electric vehicles 120 through all chargers 262, 264 and 266 at the same time, processing circuit 210 may disable some of the chargers and provide electrical energy through only the remaining chargers.

In another example embodiment, battery bank 250 includes a selector 310 and a plurality of battery packs (e.g., 322, 324, 326, 328). The power switch 240 provides electrical energy to and/or draws electrical energy from the battery packs via line 242. Line 242 may include two or more conductors. The selector 310 connects to line 242. The selector 310 steers electrical energy from line 242 to one or more battery packs 322, 324, 326, 328 or from one or more battery packs 322, 324, 326, 328 to line 242. The processing circuit 210 is configured to control the selector 310 via bus 212. When storing electrical energy in the battery bank 250, the processing circuit 210 controls the selector 310 to store energy in the battery packs 322, 324, 326 and 328. The processing circuit 210 may control the selector 310 to charge the battery packs 322, 324, 326 and 328 in any order (e.g., parallel, serially).

Once a battery pack is charged, the processing circuit 210 may configure selector 310 so that electrical energy cannot be drawn from the battery pack thereby reserving the energy stored by the battery pack for delivery at a future time. For example, assume that each battery pack 322, 324, 326 and 328 it is capable of storing 300 MW of electrical energy. If 900 MW of electrical energy must be stored for delivery at the future time, the processing circuit 210 controls the selector 310 (e.g., switch) to fully charge battery packs 322, 324 and 326. Once the battery packs 322, 324 and 326 are charged, the processing circuit 210 controls the selector 310 so that electrical energy cannot be drawn from the battery packs 322, 324 and 326. Accordingly, the required amount of energy is stored and cannot be removed from battery bank 350 regardless of the operation of the power switch 240. When the future time arrives and the energy stored in battery packs 322, 324 and 326 is needed, the processing circuit 210 operates the selector 310 so that electrical energy may be drawn from the battery packs 322, 324 and 326 for provision to electric vehicles 120.

In another example embodiment, the processing circuit 210 maintains a database 222 to facilitate energy storage for future need. Database 222 stores information regarding electric vehicles for which electric energy has been stored for delivery at a future time. Database 222 may store information for any number of electric vehicles. In an example embodiment, information for a single electric vehicle is stored as a record (e.g., 410, 420). The database 222 may include any number of records. In an example embodiment, the record 410 includes vehicle identifier 430, amount energy reserved 432, estimated delivery date and time 434, confirmed 436, user confirmation method 438, user identifier 440 and predicted energy needed 442 (e.g., estimated energy needed). Record 420, and any additional records, contains the same type of information (e.g., 430-442) as record 410.

The vehicle identifier 430 identifies the vehicle for which electrical energy has been stored for delivery at the future time. Amount of energy reserved 432 specifies the amount of electrical energy stored or to be stored in the battery bank 250 for future delivery to the electric vehicle identified by vehicle identifier 430. The predicted energy needed 442 is the amount of energy that will need to be delivered to the electric vehicle when the electric vehicle is charged. If the amount of energy reserved 432 is less than the predicted energy needed 442, the electric vehicle will need all of the stored electrical energy plus electrical energy from the transmission lines 112 and/or the local sources 280 when it is charged.

The estimated delivery date and time 434 is the predicted time as to when the electric vehicle will need to be charged. Confirmed 436 records whether the user has confirmed that they will arrive to charge the electric vehicle at the predicted delivery time. If confirmed 436 indicates that the user has confirmed the predicted delivery time, the estimated delivery date and time 434 is no longer an estimate but is a reserved date and time. The user confirmation method 438 records how the user confirmed the predicted delivery time 434. If the user took a physical action to confirm the predicted delivery time 434, then the processing circuit 210 presumes that the user is fully aware of the appointment date and time, so the processing circuit 210 take action to store the amount of energy reserved 434 in the battery bank 250. The user identifier 440 identifies the specific user who confirmed the predicted delivery time 434. If demand is low at the specific charging station, the processing circuit may store the amount of energy reserved 434 in the battery bank 250 regardless of whether the user confirms or not.

The processing circuit 210 may determine the amount of energy that should be stored in the battery bank 250 at any time by summing the amount energy reserved 432 for each record (e.g., 410, 420). The processing circuit 210 may use the predicted delivery time 434 (e.g., with confirmation, without confirmation) to determine how long the battery bank 250 must store the amount of energy reserved 432 and when it may be released from the battery bank 250. After the amount energy reserved 432 is delivered to the electric vehicle with the vehicle identifier 430, the record may be removed from database 222. When the server 140 predicts that energy needs to be reserved for future demands of a particular electric vehicle, the server 140 may instruct the processing circuit 210 of the specific charging station to create and store a new record in the database 222.

### Vehicle Identifier Verification Prior to Delivery

Stored energy that has been reserved for a particular electric vehicle 120 should not be released (e.g., delivered) to any other electric vehicle 120. In an example embodiment, the charging station 200 verifies that reserved energy is provided to the correct electric vehicle 120. In an example embodiment, electric vehicle 500 arrives at the specific charging station 200. The specific charging station 200 has reserved and stored electrical energy for the electric vehicle 500 in the battery bank 250. The user of the electric vehicle 500 inserts the handle (e.g., 272) of the assigned (e.g., reserve) charger (e.g., 262) into the socket of the electric vehicle 500. The socket electrically couples the handle 272, and thereby the charger 262, to the electric vehicle 500 to transfer electrical energy from the specific charging station 200 to the electric vehicle 500.

The electric vehicle 500 includes detector 530. The detector 530 detects the physical presence of the handle 272. The detector 530 may detect the physical presence of the handle by either physically detecting (e.g., mechanical switch) the position of the handle 272 in the socket or by wirelessly detecting the handle 272. Wireless detecting of the handle 272 may be accomplished using Near-Field Communication (NFC). An example embodiment of wirelessly detecting the presence of the handle 272 using NFC is described in U.S. provisional patent application 63/467,869 filed May 19, 2023 with docket no. 1807.142.020, which is incorporated herein by reference in its entirety and for any purpose.

Once the detector 530 detects the physical presence of the handle 272, the processing circuit 510 may send the vehicle ID 512 to the processing circuit 210 via communication circuit 520. The processing circuit 210 may compare the vehicle ID 512 to the vehicle identifier (e.g., 430) of all the records stored in the database 222 to determine whether or how much of the energy stored in the battery bank 250 has been reserved for the electric vehicle 500. In another example embodiment, the vehicle ID 512 is sent to the processing circuit 210 via the handle 272, the cable 540, the charger 262 and the bus 212. Once it has been determined that the electric vehicle 500 should receive stored energy from the battery bank 250, the processing circuit 210 configures the power switch 240 and/or the selector 310 to deliver the electrical energy from the battery bank 250 to the electric vehicle 500. The processing circuit 210 may further configure power switch 240 to delivered electrical energy from transmission lines 112 and/or the local sources 280 to the electric vehicle 500 to provide at least the predicted energy needed 442.

### User Types

As discussed above, each user has different tolerances (e.g., preferences) regarding, inter alia, the information identified in Table 6 below.

TABLE 6
User Tolerances

location of charging station,
time required to charge,
cost to recharge,
waiting time in line to get services,
convenience of services (e.g., convenient road access, covered area), and
class (e.g., amenities) of charging station (e.g., charging only, charging
plus waiting room, charging plus convenience store, charging plus
restrooms, truck-stop-like charging station).

The server 140 is configured to control, at least in part or in cooperation with the processing circuit 210, the equipment resources of each charging station 110 in an attempt to meet the service expectations of the various users. Types of users in four differing circumstances are discussed below. The information used by the server 140 to attempt to meet the expectations of the users is discussed. Further, the actions that the server 140 and/or the control circuit 210 can take to control the equipment of the charging station 110 is further discussed.

The server 140 may use machine learning techniques to analyze the data provided by the charging stations 110, the data provided by the electric vehicles 120, the data regarding user types and/or each user to determine actions the server 140 and/or the processing circuit 210 may take to provide the service expected by each user type. In the event that the expectations of user cannot be met, the server 140 may inform a user that their service expectations cannot be met. Machine learning techniques may be used to detect patterns in the data stored in database 160 and to predict the need for services in the future. Server 1140 may configure the charging stations 110 to attempt to meet the predicted future needs of the electric vehicles 120 and the service expectations of the users.

### Time Sensitive Users

One group of users includes those customers who are sensitive to the amount of time it takes to charge their electric vehicle. If the expectations of this group of users are met, these users are likely to be the best and most loyal customers because they are less sensitive to the cost of recharging, so they may be willing to pay more for faster service. An approach for servicing this group of customers may include a subscription plan. The users of this group are referred to as top tier users. It is conceivable that the services provided to top tier users may be limited to the users of a specific brand of electric vehicle.

Top tier users may include people who are creatures of habit in that they generally charge at the same charging stations at about the same time over an interval of time (e.g., week, month). The people of this group dislike spending time waiting for the electric vehicle to charge. They are willing to make a reservation to receive services; however, in accordance with various embodiments of the present disclosure, the server 140 may predict the next time of service and propose a future reservation to the user. If the user confirms the proposed future reservation, the server 140 and/or the charging stations 110 take actions to ensure that the user rule receives the level of service that they expect. Providing the expected level of service may include storing electrical energy for delivery to the electric vehicle of the user at the future time. In an embodiment, the server 140 sends a notice of a predicted future reservation to the user, but both the server 140 and/or the charging stations 110 take action to be able to service the user's electric vehicle without receiving confirmation from the user. In the event that the user does not arrive at the service station at the reserved time, the charging station 200 may use any electrical energy stored in the battery bank 250 for other purposes.

In an example embodiment, in order to predict the date and/or time of the next service and to provide faster service, the server 140 tracks information regarding the top tier users such as, inter alia, charging stations used for services, time of receiving service, date of receiving service, amount of energy received, percent of charge on battery prior to charging, percent of charge on battery after charging, rate of energy usage throughout the time interval, user identity and vehicle identity. The server 140 may additionally receive and track any of the information discussed above (e.g., Tables 1-6).

The server 140 uses the information to predict the date, the approximate time, the charging station and/or the amount of energy needed to service the electric vehicle of the top tier user. The server 140 may use the predicted information to reserve a bay at the predicted charging station at the predicted time. The server 140 informs the user of the reservation.

The server 140 may also use the predicted information to ensure that the charging station will have the amount of electrical energy needed to charge the user's vehicle. The server 140 may analyze past use of the predicted charging station to predict energy demand for the predicted time reserved for the top tier user. If the server 140 determines that the charging station will likely not have sufficient electrical energy to rapidly charge the top tier user's vehicle, the server 140 instructs the charging station 200 to store electrical energy in its battery bank 250 for delivery to the vehicle of the top tier user at the predicted time.

In an example embodiment, the server 140 determines that due to normal demand at the predicted date and time, the transmission lines 112 will be capable of providing only 40% of the needed electrical energy to charge the top tier user's vehicle. The server 140 instructs the processing circuit 210 to store an amount of energy equal to 60% of the expected needed electrical energy to charge the top tier user's vehicle. Responsive to the instruction, the processing circuit 210 controls power switch 240 and/or selector 310 to store the requested amount of energy in the battery bank 250. Depending on demand, the processing circuit 210 may need to limit the amount of electrical energy provided via the bays (e.g., 262, 264, 266) until the needed amount of electrical energy has been stored in the battery bank 250. For example, the processing circuit 210 may determine that six hours prior to the reservation time, the amount of electrical energy provided via the bays needs to be decreased by 15% in order to store the needed energy in the battery bank 250. Limiting the electrical energy delivered via the bays means that it will take longer for other users to charge their vehicles at the chargers 260. However, limiting the electrical energy to the bays ensures that there will be a sufficient amount of electrical energy to charge the top tier user's vehicle in a timely manner.

When the time of the reservation arrives, the top tier user arrives at the charging station 110, which may even have a bay reserved for the user. The processing circuit 210 configures the power switch 240 and/or the selector 310 to deliver electrical energy to the electrical vehicle from the transmission lines 112, the local sources 280 and/or the battery bank 250. Because the needed energy is available, it may be delivered to the top tier user's vehicle in a timely manner thereby meeting the expectations of the top tier user.

The server 140 may use machine learning to analyze stored information regarding the top tier user and regarding the charging station that will service the top tier user. Machine learning may be used to identify patterns in the behavior of the top tier user. The patterns may be used to predict future needs as discussed above. Machine learning may also be used to identify patterns in the usage of the charging stations. The patterns will enable the server 140 to predict energy demand and to determine the amount of electrical energy to store in the battery bank 250 to meet the future needs of top tier users. In an example embodiment, the processing circuit 210 configures the power switch 240 to deliver electrical energy at a lower rate while the vehicle of the top tier user is being charged so that a higher percentage of the electrical energy from the transmission lines 112 and/or the local sources 280 may be provided the top tier user's electric vehicle. Once the top tier user's electric vehicle has been charged, the processing circuit 210 may reconfigure the power switch 240 to provide all of the electrical power from the transmission lines 112 and/or the local sources 280 to the remaining electric vehicles. In other words, providing charging services to top tier users takes priority over providing charging services to users who are not top tier users.

### Time Sensitive but Less Predictable Users

Another group of users, referred to as middle tier users, includes those customers who are also sensitive to the amount of time it takes to charge their electric vehicles; however, their lives are less regular than those of the top tier users. Because the middle tier users have fewer set patterns or times with respect to charging their electric vehicles, is more difficult to predict a time and a place for service. However, the middle tier users want quick access to charging services when needed and do not mind driving a reasonable distance to get service. They are unwilling to make reservations far in advance and want on-demand service. Further, the middle tier users want to spend as little time as possible charging their vehicles but realize that they may need to take what they can get. Middle tier users may be willing to pay a small amount to identify the closest charging station that can provide the best service. The servicing of this group of customers may also be amenable to a subscription plan.

To provide service to middle tier users, the server 140 needs information regarding the middle tier user and their electric vehicles. The server 140 needs to know, inter alia, the present location of the middle tier user's vehicle, the amount of electrical energy presently in the battery, the amount of electrical energy that will be needed, the remaining range of travel of the electric vehicle, time to depletion of the battery, and present rate of use of electrical energy from the battery. The server 140 may additionally receive and track any of the information discussed above with respect to Tables 1-6.

The server 140 also needs information regarding charging stations 110 in an area that are accessible to the middle tier user's electric vehicle (e.g., within range for the amount of energy stored in the battery). Regarding the charging stations in the area, the server 140 needs to know, inter alia, current usage, bay availability, number of electric vehicles waiting in line, estimated charging times of electric vehicles presently being charged, a prediction of the amount of energy available for delivery to the middle tier electric vehicle, the amount of electrical energy stored in the battery bank 250, any upcoming reservations for top tier users and required energy for upcoming top tier users. The server 140 may additionally receive and track any of the information discussed above with respect to charging stations 110 (e.g., Tables 1-2).

When a middle tier user desires to charge their electric vehicle, the server 140 assesses the user's needs and the capabilities of the charging stations 110 in the area. The server 140 presents a list of available charging stations 110 to the user (e.g., via a smart phone, tablet, computer). Information regarding each charging station on the list may include information such as, inter alia, distance into the charging station, wait-time to receive service if any, estimated charging time and cost. The user may select one of the charging stations 110 from the list. Selection of one of the charging stations 110 from the list requires a physical act to be taken by the user, so the server 140 will respond by taking the actions necessary to provide service as selected by the middle tier user. An example embodiment, responsive to the selection, server 140 instructs the selected charging station to reserve a bay for the middle tier user.

In another example embodiment, once the middle tier user arrives at the charging station and begins charging the electric vehicle, the charging station will reduce the rate of energy delivery to electric vehicles that do not belong to first-tier or second tier users and direct the additional electrical energy to the second tier user to reduce the amount of time it takes to charge the vehicle of the second tier user. In other words, the charging station will prefer second tier users over all other users except for other second tier users and first-tier users.

In another example embodiment, the server 140 controls the charging stations 110 to store a certain amount of energy in their respective battery banks 250 to provide to middle tier users in general, and not specific users, to decrease the amount of time it takes to charge middle tier electric vehicles. Server 140 may analyze electrical energy usage and middle tier demand over time to determine the amount of energy to reserve in the battery banks 250 of the respective charging stations 110 for middle tier users. Since the exact timing of middle tier user demand is less predictable, the reserved electrical energy may or may not be available for providing to middle tier users, but if reserve electrical energy is available, it is used to decrease the charging time for the middle tier users.

Server 140 may use the mathematical techniques employed by operations research to map the middle tier electric vehicles requesting service to the charging stations in the area. GIS analysis techniques may be used to determine the time at which the middle tier electric vehicle can arrive at an assigned or selected charging station.

### Lowest Tier Users

Another group of users, referred to as the lowest tier users, includes those customers who want fast charging and predictable access but are unwilling to pay for higher tiers of service (e.g., a subscription service). The lowest tier users are willing to schedule a reservation. For this lowest tier, the server 140 tracks charging station availability and handles reservation making; however, priority is given to users of higher tiers and a predicted reservation by a higher tier user will preempt a reservation for a lowest tier user. Because the server 140 tracks predicted energy usage for higher tier users and demand patterns at the various charging stations 110, the server 140 may be able to provide the lowest tier users with a list of reservation times at a variety of specific charging stations along with information as to the predicted time it will take to charge the lowest tier user's vehicle. The lowest tier user may select a reservation time and charging station that has an acceptable predicted charging time. However, since a second tier user may arrive in the amount of charge provided to a lowest tier user reduced for a period of time, the predicted charging time provided to a lowest tier user is only an estimate.

### No Tier Users

Users who want on-demand service, much like conventional service stations today, belong to what is referred to as the no tier users. These users are unwilling to pay for higher tiers of service and move between competing charging systems (e.g., competitors) to find acceptable service and pricing. The no tier users seek the best service for the best price that they can find. The server 140 generally does not track information from the no tier electric vehicles or users; however, when service is provided to a no tier user, the vehicle ID and information related to services provided is stored in database 160. No tier users arrive at a charging station where a bay may or may not be available and receive services as can be provided at the time.

### In Operation

Example—Top Tier User

The top tier user of electric vehicle 712 lives at house 710. The top tier user has a very structured life, which includes shuttling children to various schools and activities (e.g., swim team at waterpark 740) during the school year and living at the lake house 810 during the summer. During the school year, the top tier user charges electric vehicle 712 each Monday at charging station 720 at about 9:00 AM after taking the children to school and at charging station 732 at about 4:30 PM on Friday afternoons after dropping the children off for swim lessons. Once a month, the top tier user drives the electric vehicle 712 to small town 800 to participate in an architectural preservation board meeting, which necessitates charging at charging station 734 on the way back home.

The electric vehicle 712 reports the information identified above (e.g., Table 3) regarding its operation to the server 140. The server uses the information to predict the date and time of future charging services and reserves a charger (e.g., 262, 264, 266) at charging station 720 at about 9 AM on Mondays and a charger the charging station 732 at about 4:30 PM on Fridays. Generally, the user confirms the reservations, so the server 140 instructs the charging station 720 and 732 to reserve electrical energy for delivery to the electric vehicle 712 at the reserved times. In the event that the user does not confirm a reservation proposed by the server 140, the server 140 instructs the charging stations 720 and 732 to reserve a needed amount of energy if possible in accordance with demand.

The day of the meeting board varies during the month; however, server 140 may detect a pattern to predict the day and then detect when the electric vehicle 712 is headed toward small town 800. On the day when the electric vehicle 712 drives to the small town 800, the server 140 may reserve a charger at charging station 734 for a time range of the predicted time of return to the big city 700.

During the summer, while the top tier driver and the electric vehicle 712 are primary located at the lake house 810, the server 140 tracks the usage of the electric vehicle 712 and predicts a date and time for service at charging station 820.

During the summer, the top tier user and the family travel on vacation in electric vehicle 712. Because the server 140 can detect no pattern to the travel, predicted reservations may not be set. However, in an example embodiment, while the top tier user and family travel on vacation, the server 140 provides the top tier user with the matching service provided to middle tier users, so that electric vehicle 712 may receive efficient on-demand service or at least as efficient as possible. In another example embodiment, during the summer, the top tier user provides information to the server 140 regarding the planned route of travel. The server 140 may monitor the movement of the electric vehicle 712 against the plan and may predict locations where the electric vehicle 712 may receive service. Because the need for service can be predicted, the server 140 may identify an appropriate charging station, set a reservation for a specific time, reserve energy to charge the electric vehicle 712 and inform the top tier user of the reservation. The user may confirm any proposed reservations.

Example—Top Tier User

Another top tier user drives vehicle 762 and lives in house 760. The user works in office district 770. The user prefers to charge at charging stations 722, 726, 730 or 734 located along Expressway 750 due to the convenience of access; however, the preferred charging station is charging station 730. This user generally charges the battery when the charge on the battery gets to around 10% of the capacity and only charges up to 90% of the capacity of the battery in the hope of extending the life of the battery.

This user does not have as regular a schedule as the other top tier user discussed above. Monday through Friday, this user commutes from the house 760 to the office district 770. Many days of the week, the user will drive to restaurants in the business district 772 along Expressway 750. The user goes out two nights a week to enjoy some type of activity. One of the nights falls on any of the days Monday through Thursday. The other night out, always falls on Friday. The activity may involve driving between various places. While the user is out for the night, the user dislikes stopping to charge the vehicle, so if the battery charge is less than 30%, the user will stop to charge the battery before the night's activities. The user also drives to the small town 800 generally one night per week to visit family. At times, the drive to small town 800 is part of his/her nights out for the week.

Part of the user's job is to monitor the production of prototypes being produced in industrial parks 774. Depending on the stage of the project and the complexity of the prototype, the user may need to make several trips between the office district 770 and the industrial park 774 daily.

With this user, the server 140 has detected that the vehicle 762 is only charged at charging stations 722, 726, 730 or 734 and primarily at charging station 730. The server 140 also detected the other patterns in charging, in particular the amount of charge on the battery at the time of charging and at the time just after charging. The server 140 detects whatever patterns it can in the user's routine and where possible schedules a reservation at the appropriate charging station. Because the user can reject the reservation or simply not confirm, when user's electric vehicle does not arrive at the charging station at the predicted reservation time, the server 140 attempts to reserve electrical energy for the user at a time close to a second predicted time of recharging possibly at a second predicted charging station.

Example—Middle Tier User

A middle tier user lives in house 714 and drives vehicle 716. The middle tier user works in sales and drives all over the big city 700. The middle tier user does not want predicted reservations because the reservation may be scheduled over a meeting or at an inconvenient location. The middle tier user wants service when needed and is willing to drive to just about any charging station in the big city 700. When server 140 predicts that the middle tier user needs charging services, server 140 presents the list of available charging stations with the information regarding the services that may be provided, including an estimated charging time. The middle tier user selects a charging station from the list, the server 140 reserves a charger at the selected charging station and the middle tier user drives the vehicle 716 to the selected charging station to receive service. As discussed above, the middle tier user may receive charging preference at the selected charging station. The mathematics used in operations research may be used to match the vehicle to the charging station.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A system for charging electric vehicles, the system comprising:
a server;
a plurality of charging stations positioned throughout a geographic area, each charging station of the plurality of charging stations includes a battery bank respectively;
a plurality of electric vehicles; wherein, the server is configured to:
receive a first information from each electric vehicle the plurality of electric vehicles;
receive a second information from each charging station of the plurality of charging stations;
analyze the first information and the second information to detect a first pattern of use with respect to a first electric vehicle of the plurality of electric vehicles;
analyze the first information and the second information to detect a second pattern of use with respect to one or more charging stations of the plurality of charging stations;
predict in accordance with the first pattern of use and the second pattern of use, a future time when the first electric vehicle will seek charging services at a first charging station of the plurality of charging stations;
predict a first amount of electrical energy that will be needed by the first electric vehicle; and
transmit an instruction to the first charging station to store a portion of the first amount of electrical energy in the battery bank of the first charging station for delivery to the first electric vehicle at the future time; and
responsive to the instruction, the first charging station is configured to:
receive a second amount of electrical energy from a transmission line; and
steer a portion of the second amount of the electrical energy to the battery bank of the first charging station to store the first amount of electrical energy in the battery bank of the first charging station.

2. The system of claim 1 wherein the server is further configured to determine the portion of the first amount of electrical energy to store in the battery bank of the first charging station.

3. The system of claim 1 wherein the future time includes a date and a time of day.

4. The system of claim 1 wherein the first charging station further comprises a power switch and a processing circuit, wherein responsive to the instruction, the processing circuit controls the power switch to store the portion of the first amount of electrical energy in one or more battery packs of the battery bank of the first charging station.

5. The system of claim 1 wherein the first charging station is further configured to deliver the portion of the first amount of electrical energy from the battery bank of the first charging station responsive to verifying an identifier of the first electric vehicle.

6. The system of claim 1 wherein the first charging station is further configured to store the portion of the first amount of electrical energy in the battery bank of the first charging station responsive to a physical act taken by a user of the first electric vehicle to confirm the future time for delivery.

7. A system for charging electric vehicles, the system comprising:
a server;
a plurality of charging stations positioned throughout a geographic area, each charging station of the plurality of charging stations includes a battery bank respectively;
a plurality of electric vehicles; wherein, the server is configured to:
analyze a first information regarding use of each electric vehicle and a second information regarding use of each charging station to detect a first pattern with respect to charging a first electric vehicle of the plurality of electric vehicles;
predict in accordance with the first pattern, a future time when the first electric vehicle will seek charging services at a first charging station of the plurality of charging stations; and
transmit an instruction to the first charging station to store a first amount of electrical energy in the battery bank of the first charging station for delivery to the first electric vehicle at the future time; and
responsive to the instruction, the first charging station is configured to:
receive a second amount of electrical energy from a transmission line; and
steer a portion of the second amount of the electrical energy to the battery bank of the first charging station to store the first amount of electrical energy in the battery bank of the first charging station.

8. The system of claim 7 wherein the server is further configured to receive the first information from each electric vehicle the plurality of electric vehicles.

9. The system of claim 7 wherein the server is further configured to receive the second information from each charging station of the plurality of charging stations.

10. The system of claim 7 wherein the server is further configured to predict the first amount of electrical energy to store in the battery bank of the first charging station.

11. The system of claim 7 wherein the future time includes a date and a time of day.

12. The system of claim 7 wherein the first charging station is further configured to reserve a charger at the first charging station for the future time for delivery of the first amount of electrical energy to the first electric vehicle.

13. The system of claim 7 wherein the first charging station further comprises a power switch and a processing circuit, wherein responsive to the instruction, the processing circuit controls the power switch to store the first amount of electrical energy in one or more battery packs of the battery bank of the first charging station.

14. The system of claim 7 wherein the first charging station is further configured to deliver the first amount of electrical energy from the battery bank of the first charging station responsive to verifying an identifier of the first electric vehicle.

15. The system of claim 7 wherein the first charging station is further configured to store the first amount of electrical energy in the battery bank of the first charging station responsive to a physical act taken by a user of the first electric vehicle to confirm the future time for delivery.

16. The system of claim 7 wherein the server is further configured to transmit an instruction responsive to a physical act taken by a user of the first electric vehicle to confirm the future time for delivery.

17. A system for charging electric vehicles, the system comprising:
a server;
a plurality of charging stations positioned throughout a geographic area, each charging station of the plurality of charging stations includes a battery bank respectively;
a plurality of electric vehicles; wherein, the server is configured to:
predict a future time when a first electric vehicle of the plurality of electric vehicles will seek charging services at a first charging station of the plurality of charging stations; and
transmit an instruction to the first charging station to store a first amount of electrical energy in the battery bank of the first charging station for delivery to the first electric vehicle at the future time; and
responsive to the instruction, the first charging station is configured to store the first amount of electrical energy in the battery bank of the first charging station.

18. The system of claim 17 wherein the first charging station further comprises a power switch and a processing circuit, wherein responsive to the instruction, the processing circuit controls the power switch to store the first amount of electrical energy in one or more battery packs of the battery bank of the first charging station.
